(19) United States
(12) Patent Application Publication
(10) Pub. No.: US 2013/0264291 A1
(43) Pub. Date: Oct. 10, 2013

(54) METHOD AND APPARATUS FOR TREATING DRINKING WATER

(71) Applicant: David Itzhak, Tel-Aviv (IL)

(72) Inventor: David Itzhak, Tel-Aviv (IL)

(21) Appl. No.: 13/811,441

(22) PCT Filed: Jul. 20, 2011
(86) PCT No.: PCT/IL11/00581

§ 371 Date: Jun. 4, 2013

Related U.S. Application Data
(60) Provisional application No. 61/366,557, filed on Jul. 22, 2010.

(51) Int. Cl. C02F 1/467

(52) U.S. Cl. CPC C02F 1/4674
USPC 210/748.2; 210/137; 210/96.1

(57) ABSTRACT

A method for chlorination of drinking water, comprising providing a main water stream flowing through a main water pipe at a volumetric flow rate of not less than 30 m3/hour, splitting off a portion of said main water stream to form a side water stream flowing through a side pipe, passing said side water stream through a plurality of electrolysis modules at a linear velocity of not less than 0.35 m/s, wherein each electrolysis module comprises at least one anode and one cathode, electrolyzing the side water stream, and directing the resultant electrolyzed side water stream, which contains free chlorine, back to the main stream. An apparatus for carrying out the method is also disclosed.

### FIELD OF THE INVENTION

The invention relates to an electrolysis-based method for the chlorination of drinking water supply systems, such as those commonly operated by public water suppliers.

### BACKGROUND OF THE INVENTION

The maintenance of biologically safe drinking water is commonly achieved through the addition of chlorine, which is a powerful disinfectant. The allowed level of residual free chlorine in drinking water is between 0.2 and 0.5 ppm, although it is permitted, in the case of need, to reach temporary chlorine levels of up to 1-2 ppm through shock chlorination.

It is known that the electrolysis of chloride-containing aqueous solutions yields molecular chlorine at the anode, and hydrogen gas and metal hydroxide at the cathode, according to the following equation (where the chloride source is NaCl):

2Na⁺+2Cl⁻+2H₂O→2Na⁺+2OH⁻+Cl₂+H₂

Molecular chlorine may then react with sodium hydroxide to form sodium hypochlorite. Throughout the description, the terms “residual chlorine”, “free chlorine” or “chlorine-containing compounds” are interchangeably used to indicate aqueous molecular chlorine (Cl_{2(aq)}), hypochlorite (OCl) or other species which contain chlorine in an oxidation state other than −1 (such as chlorine dioxide), which species are obtainable under non-selective electrolysis, where there is no membrane separation interposed between the electrodes. Other useful disinfectants which may be formed under such conditions in the anolyte include hydroxyl radical and hydrogen peroxide.

Water streams generated by suppliers of drinking water and being conveyed to the public from groundwater and surface water sources generally have volumetric flow rates between 5 and 500 cubic meters per hour, and more typically between 30 and 150 cubic meters per hour. The chlorination of drinking water may be accomplished through one of the following methods:
(i) production of a reservoir of hypochlorite solution, which is periodically fed into the stream of drinking water;
(ii) on-line, essentially continuous electrolysis of the water stream itself.

The first method is currently used by water suppliers and is based on the application of an electrical current to an alkali or alkaline earth metal chloride solution (brine), to produce a hypochlorite solution (e.g., NaOCl), as described above. The hypochlorite solution is stored in a suitable tank at the relevant location, namely, in the vicinity of the water pumping station. The hypochlorite solution is periodically fed into the drinking water to maintain the quality of the water. The main drawback of this method stems from the fact that the potentially dangerous hypochlorite reservoir requires careful storage conditions and in addition, the hypochlorite is an unstable compound which tends to degrade in the storage tank.

According to the second method, the stream of drinking water flowing in a pipeline undergoes on-line electrolysis, using suitable electrolytic cells located along the line, resulting in the in-situ electro-chlorination of the water. Ideally, the electrolysis should make use of the natural salinity of the water recovered from various sources (either underground or surface water), without any addition of chloride salts, in order to eliminate the potential problem associated with the need to inject into the water pipeline a chloride salt from an external container located in the water pumping station.

From safety and security perspectives, “on-line electrolysis” is favored over the first method. However, the reduction to practice of the “on-line electrolysis” method by public water suppliers operating water pumping stations is expected to meet with considerable difficulties, chiefly for the following reasons: the natural salinity of the water, namely, the chloride content which serves as a source for free chlorine, is considered too low; scale formation interferes with the operation of the electrolytic cells; sizeable electric power is consumed by the electrolytic cells; interruptions and resumptions taking place at the water pumping station are likely to generate working pressures of considerable magnitudes (water hammer effect) which may cause the collapse of the electrolytic cells along the pipeline.

WO 03/55806 describes a method for disinfecting water in a water supply system. According to WO 03/55806, part of the water is guided through an electrolytic cell and the resultant electrolyzed stream is then returned to the water supply system. A chloride salt is added to the water stream to be electrolyzed prior to the electrolytic process.

U.S. Pat. No. 6,217,741 illustrates an apparatus for sterilizing water. According to FIG. 5 of U.S. Pat. No. 6,217,741, raw water transport pipe 2 is separated off into two streams designated Y1 and Y2. Hydrochloric acid is injected into the second stream Y2, which is then caused to flow through an electrolytic cell. The electrolytically treated water stream, indicated X2, finally joins the raw water stream Y1.

### SUMMARY OF THE INVENTION

We have now found that it is possible to render high volumetric flow rate streams of drinking water biologically safe, by the use of an electrolytic method based on the natural salinity of the water source, while overcoming the problems related to scale deposition and the sudden formation and propagation of pressure waves along the pipeline. The method of the invention may be carried out by the water supplier at the water pumping station by integrating the apparatus of the invention with the pipe conveying the water stream produced by the pumping station.

The present invention primarily relates to a method for chlorination of drinking water, comprising providing a main water stream flowing through a main water pipe at a volumetric flow rate of not less than 30 m³/hour, splitting off a portion of said main water stream to form a side stream flowing through a side pipe, passing said side water stream through a plurality of electrolysis modules at a linear velocity of not less than 0.35 m/s, wherein each electrolysis module comprises at least one anode and one cathode, electrolyzing the side water stream, and directing the resultant electrolyzed side water stream, which contains free chlorine, back to the main stream.

The term “main water stream”, as used herein, refers to a water stream generated and conveyed by water suppliers from groundwater or surface water sources or from desalination plants, with characteristic volumetric flow rates in the range between 30 and 500 cubic meters per hour, and more preferably in the range between 50 and 150 cubic meters per hour, e.g., about 100-120 m³/h. The natural salinity of the raw, main water stream treated by the method of the invention (namely, the chloride content as NaCl) is about 70-400 mg/liter, which corresponds to conductivity values in the range between 400-1500 μS/cm. According to the method of the invention, there is no need to add chloride from an external source to the water stream and therefore the salinity of the side water stream subjected to electrolysis is the water natural salinity.

Preferably, the side pipe comprises two non-contiguous sections, an upstream inlet section and a downstream outlet section, wherein the electrolysis modules are hydraulically connected in series and positioned between said sections. The preferred electrolysis module suitable for use in the method of the invention comprises an interior cylindrical (or frusto-conical) passage for flow of a liquid therethrough. The serial arrangement set forth above and illustrated in FIG. 1 provides a continuous flow path, through which the side water stream flows.

The side water stream is passed through the electrolysis modules at high linear velocity, preferably between 0.5 and 2 m/s. The high linear velocity is suitably adjusted by using a side water pipe having cross-section smaller than the cross-section of the main water pipe, and regulating the volumetric flow rate through the side water pipe. Preferably, the ratio between the diameter of the main water pipe and the diameter of the upstream inlet section of the side water pipe is at least 2:1, e.g., between 2:1 and 5:1, preferably about 3:1.

According to a specific embodiment of the invention, the side water stream is passed through at least three electrolysis modules which are electrically connected in parallel to a power source and operate at a voltage in the range from 10 volts to 22 volts, wherein each module comprises p electrodes, p being an integer preferably between 3 and 15, and wherein said electrodes are arranged to provide p−1 electrolytic cells within the electrolysis module. A particularly suitable electrodes assembly is described in more detail hereinafter.

### DETAILED DESCRIPTION OF THE INVENTION

The electrolysis modules are hydraulically connected in series and positioned between the upstream inlet and downstream outlet sections of the side water pipe, as schematically illustrated in FIG. 1. A main water stream 1w is driven from a water source 2 along a main pipe 1. A side water stream 3w is withdrawn from said main stream and is caused to flow through a side pipe 3 having an upstream inlet section 3e and a downstream outlet section 3r. The outside diameter of the main pipe 1 is typically about 4-12 inches and the diameter of the inlet and outlet sections of pipe 3 is between 1-4 inches. Flow control devices and pumps (e.g., butterfly or ball valves of known designs), are suitably located in order to regulate the flow of water through the pipes 1 and 3 conveying the main and side streams, respectively. For example, as shown in FIG. 1, a butterfly valve 4 is suitably rotated in order to produce a side water flow 3w along pipe 3, while the path of the main flow 1 remains almost unblocked. Additional valves 4a are located in order to disconnect the water pipe 3. The pressure difference necessary for driving the side water stream 3w from inlet 3e to outlet 3r through the sequence of electrolytic modules may be provided by a pump with throughput of up to 20 cubic meters per hour.

Numerals 5₁, 5₂, . . . 5ₙ indicate the plurality of electrolysis modules which are hydraulically connected in series and positioned between the inlet and outlet sections of the side pipe 3 and are electrically connected in parallel to a power source 6 (e.g., a rectifier supplying direct current; hereinafter “DC supplier”). In general, a suitable DC supplier is capable of providing direct current of up to 120 Ampere and voltage of up to 24 Volt. The number of electrolysis modules used depends on the structure and characteristics of the electrolytic cells placed in each module, as described in detail below, and also on the natural salinity of the raw water source (the lower the water salinity, the greater the number of electrolysis modules used).

Flow and pressure measurement devices (7, 9) (e.g., GEORG FISCHER Variable Area Flow Meter 198 335 009) can also be placed along the pipe 3. For example, a rotameter may be interposed between two adjacent electrolysis modules. Numeral indicates a vent (e.g., A.R.I. 040) used for releasing gaseous products of the electrolysis. Numeral 10 indicates chlorine measurement device (e.g., Prominent DULCOMETER® D1C Single Channel Controller employing a prominent CLE 3 (0.1)-mA-xppm sensor) positioned downstream, in order to measure the level of free chlorine generated according to the method of the invention.

Control unit 19 (e.g., control logic, programmable logic control, or the like) may be used to control the downstream chlorine levels in main pipe 1. Control unit 19 is preferably adapted to periodically or continuously receive chlorine measurements from chlorine measurement device 10 and adjust the voltage supplied by the electrical DC source 6. Control unit 19 may be configured to progressively increase the output voltage in response to low chlorine levels measurements, and to progressively decrease the output voltage in response to high chlorine levels measurements.

In operation, the side water stream 3w is caused to pass through each of the electrolysis modules 5ᵢ at a linear velocity which is not less than 0.35 m/s, preferably not less than 0.5 m/s, and more preferably about 0.5-2.0 m/s. The polarity of the electrolysis modules 5ᵢ is periodically reversed, e.g., once in 1-4 hours.

The high linear velocity side water stream is subjected to electrolysis which results in the formation of chlorine-containing compounds and other oxidant species within the side stream. The resultant chlorine-enriched side water stream exits the last electrolytic module 5n and flows through the outlet section of pipe 3 to join the main water stream 1w. As reported in the Examples below, downstream measurements indicate that the residual chlorine level required for the maintenance of biologically safe drinking water (about 0.2-0.5 ppm) is attained by the method of the invention using the natural salinity of the water source, without adding external chloride salt to the water. Furthermore, the method of the invention does not encounter serious deposition of scale in the electrolysis modules.

For chlorinating a main water stream flowing at a volumetric flow rate of 100-200 m³/h according to the embodiment illustrated in FIG. 1, it is preferred to use between 6 and 15 electrolysis modules which are electrically connected in parallel to the DC supplier, applying a voltage 8-12 V and current of 60-90 amperes.

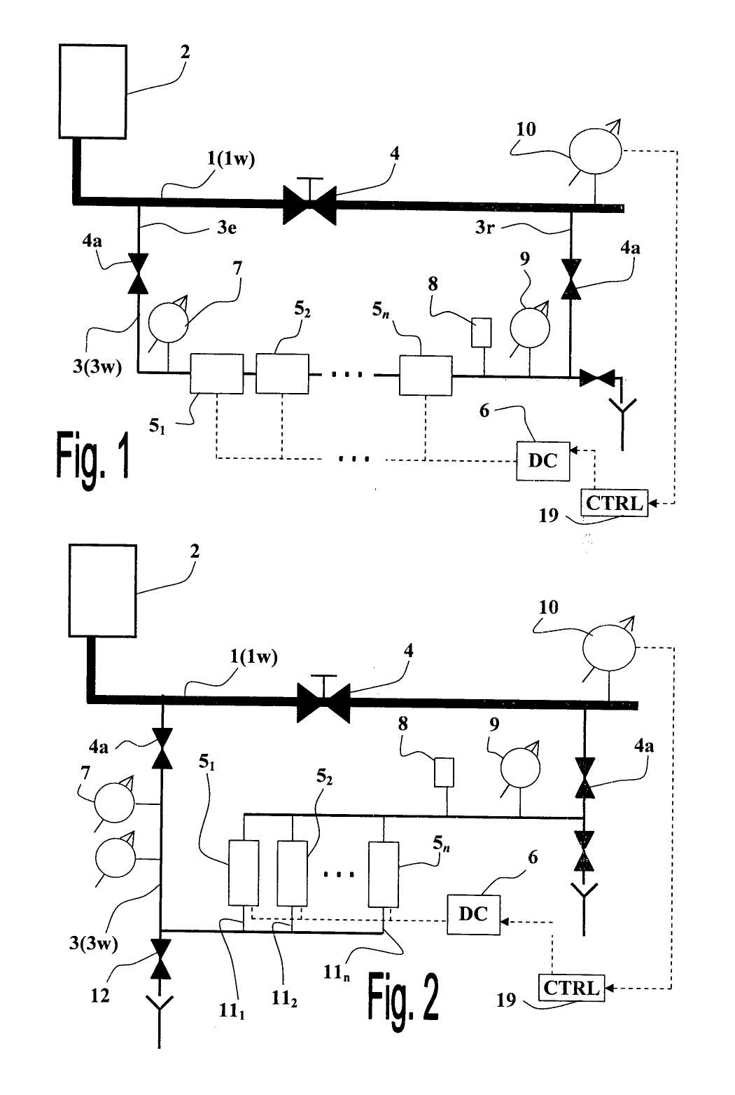

Turning now to FIG. 2, it is noted that according to another embodiment, the method of the invention comprises branching off the side water stream into two or more subsidiary streams flowing in parallel, passing each of said subsidiary streams through at least one electrolysis module, electrolyzing said streams, combining the electrolyzed subsidiary streams and directing the combined electrolyzed stream back into the main stream. In FIG. 2, numerals 1, 1w, 2, 3, 3w, 4, 5₁, 5₂ . . . 5ₙ, 6, 7, 8, 9 and 10 have the same meanings as set forth above with respect to FIG. 1. Numerals 11₁, 11₂ . . . 11ₙ indicate the plurality of subsidiary water streams into which the side water stream is split off, wherein each subsidiary stream 11ᵢ passes through one electrolysis module 5ᵢ. In the embodiment shown in FIG. 2, n may equal 6. Numeral 12 indicates a counter washing valve, which may be useful in case that washings of the pipeline is required for removing scale deposited onto the electrodes.

It should be noted that the method illustrated in FIG. 2 is especially useful for the treatment of main water streams produced and driven at volumetric flow rates of not less than 250 m³/h. The side water stream 3w is caused to flow through side pipe 3 at a volumetric rate of not less than 15 cubic meter/hour, ensuring that despite the branching off of the side stream, each subsidiary stream 11ᵢ stemming therefrom would still pass through the corresponding electrolysis module 5ᵢ at sufficiently high linear velocity. Control unit 19 may be utilized to control the downstream chlorine levels in main pipe 1, in a similar way as described above with reference to FIG. 1.

FIG. 3 illustrates the structure of an electrolysis module suitable for use in the method of the invention. It is noted that the electrolysis module 5 does not interfere with the geometry of the side pipe, and can be easily integrated with the pipe. The electrolytic module 5 comprises an essentially cylindrical casing 13 supported on a rectangular base 15 and having an inlet opening 13in and an outlet opening 13out, wherein each opening is coupled to a suitable connector (not shown), for fixing the electrolytic modules 5 to one another in series along the side pipe, as shown schematically in FIG. 1, or to the subsidiary branched-off pipes, as shown in FIG. 2.

The casing 13 is preferably made of a nonconductive material which is resistant to the electrolysis products. To this end, thermosetting transparent plastic such as acrylic polymer is suitable. On the external lateral surface of cylindrical casing 13 a plurality of equally spaced-apart rings 16 are located, and one or more vertical ribs 17 merging with rings 16, which form part of the molded casing 13. Rings 16 and ribs 17 are designed to increase the mechanical strength of the electrolysis module. The outer diameter and height of the cylindrical casing 13 are about 12-20 cm and 15-25 cm, respectively. The dimensions of the rectangular base 15, through which the electrolysis module 5 is electrically connected to the DC supplier 6, are about 12×16 cm². The distance between a pair of adjacent outer rings is about 1.5-4 cm.

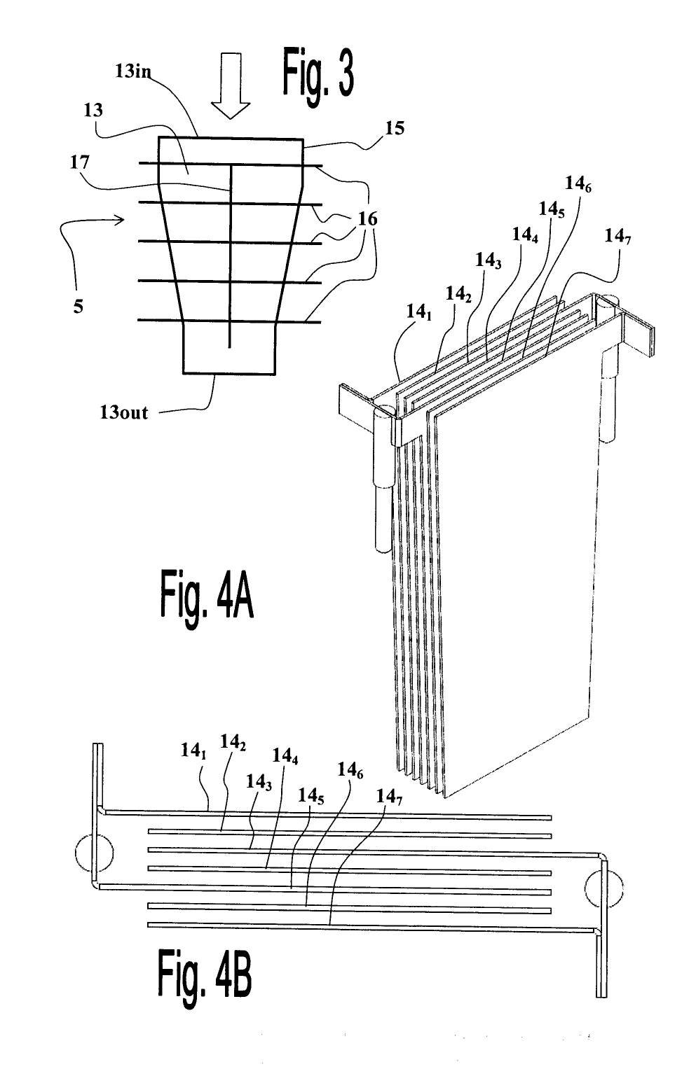

Within the cylindrical (or frustoconical) interior space of casing 13 electrodes 14₁, 14₂ . . . , 14ₚ are mounted. The number of electrodes 14 placed in each electrolysis module 5 and the dimensions of each electrode are designed to meet the needs of the method, namely, the amount of residual free chlorine to be generated in the drinking water. The specific structural and operating parameters which shall now be described in detail with reference to FIGS. 4a and 4b are considered suitable for treating a typical main raw water stream with a flow rate and natural salinity as set forth above.

FIGS. 4a and 4b illustrate the preferred mechanical and electrical features of the assembly of electrodes mounted in the electrolysis module 5. The electrodes 14₁, 14₂, . . . , 14ᵢ . . . , 14ₚ are preferably thin, flat rectangular plates, which are placed in parallel to each other and spaced about 0.1-0.5 cm apart. Alternatively, a concentric arrangement of electrodes may be used. Each electrode 14ᵢ provides about 200-400 cm² of surface area. For example, the dimensions of the rectangular electrode 14ᵢ may be as follows: length of about 15-25 cm, width of about 8-12 cm and thickness of about 0.1-0.3 cm. The electrodes may be made of various metals or combinations of metals. Preferably, the electrodes are platinum, platinum-iridium or ruthenium oxide-coated titanium plates, with the thickness of the catalytic coating being about few micrometers or even less (e.g., about 1 μm). Suitable electrodes also include titanium electrodes coated with noble metals such as platinum, iridium or metal oxide such as Ta₂O₅. M/MO₂ type electrodes, wherein M indicates a metal and MO₂ indicates metal oxide having good electrical conductivity, such as Ru/IrO₂ electrodes, are also useful according to the invention. There is no diaphragm in the electrolysis modules used.

According to a preferred embodiment of the invention, the electrode assembly mounted in each electrolysis module consists of an odd number of electrodes placed in parallel to each other. For the purpose of the present description, each electrode is assigned with a natural number indicating its position in the electrodes assembly, running from 1 to p (wherein p is an odd number indicating the total number of electrodes in the electrolysis module). The electrodes assigned with odd numbers (14₁, 14₃, 14₅, . . . , 14ₚ) are alternately connected to the opposite poles of a DC supplier (e.g., the first 14₁ and fifth electrode 14₅ are electrically connected to one pole of the power supplier whereas the third 14₃ and seventh 14₇ electrodes are connected to the other pole of the power supplier). Hence, the outermost electrodes in the electrode assembly, indicated by numerals 14₁ and 14ₚ, are electrically connected to the opposite poles of the DC supplier. It follows from the description given above that p may be equal to 7, 11, 15, etc. Preferably, p equals 7 or 11. The electrodes assigned with even numbers (2, 4, . . . , p−1) are floating electrodes, namely, they are not electrically connected to the power supplier. Following the application of voltage across the electrolysis module 5, the opposing faces of the floating electrode are oppositely charged producing p−1 cells where p is the number of electrodes.

In the specific embodiment shown in FIGS. 4a and 4b, the electrodes assembly mounted in each electrolysis module consists of seven electrodes: two active anodes (14₁, 14₅), two active cathodes (14₃, 14₇) and three floating electrodes (14₂, 14₄ and 14₆), such that there is one floating electrode interposed in the space between each pair of opposite active electrodes. There are six cells, and the voltage across each cell is v/2 where v is the applied potential. The electrodes 14₁, 14₂, . . . , 14ₚ are arranged in the interior space of the cylindrical electrolysis module 5 along planes which are essentially perpendicular to the bases of the electrolysis module. The stream of water to be electrolyzed flows through the spaces between the electrodes.

Electrolysis modules suitable for use in the method of the invention are commercially available (e.g., PSC-5 chlorinator cell from Magen Ecoenergy Ltd., Kibbutz Magen, Israel).

As mentioned above with reference to FIGS. 1 and 2, the plurality of electrolysis modules 5₁, 5₂, . . . 5ₙ are electrically connected in parallel to the DC supplier. The electrolysis module preferably operates at a voltage in the range from 10 volts to 15 volts, e.g., 12 volts, with the direct current being between 50 and 80 ampere, preferably about 60 ampere. The voltage and amperage ranges set forth above were applied in the configuration illustrated in FIG. 1 using six electrolysis modules as those commercially available from ecoenergy ltd, Israel.

According to the embodiments of the invention set forth above, only chloride salts naturally present in drinking water are used as the precursor for chlorine generation. The typical chloride level in underground drinking water (sodium chloride) is about 70-400 mg/liter, and this chloride content generally suffices for generating the desired level of chlorine-containing compounds in the major stream of drinking water. However, the method of the invention may further comprise the step of adding an auxiliary chloride source to the side water stream, prior to, or concomitantly with, the passage of the side water stream in the electrolytic modules, in order to increase the amount of chlorine-containing compounds generated by the electrolysis. The chloride salt may be provided either in a solid form or as a concentrated chloride solution having salt (e.g., sodium chloride) content in the range between 5 and 20 wt %. Most conveniently, the addition of the auxiliary chloride salt may be carried out by injecting a concentrated sodium chloride solution to the side water stream using a dosing pump and allowing the auxiliary solution to mix with said side stream. The auxiliary chloride solution may be injected into the side stream at a rate of 1-20 liters per hour for a short period of time, e.g., between five seconds and 5 minutes. Hence, the auxiliary chloride salt may be used for adjusting the residual chlorine level within a desired range. The adjustment of the chlorine level may be conveniently accomplished by measuring the conductivity of the side stream. It is understood, of course, that addition of the auxiliary chloride salt should not increase the salinity of the side water stream above an unacceptable level.

In another aspect, the invention provides water supply system suitable for use in a water pumping station, comprising:

a main water pipe 1 conveying water at a flow rate of not less than 30 m³/hour;

a side water pipe 3 having an inlet and outlet sections in fluid communication with said main pipe 1;

flow control devices 4, 4a for regulating and controlling the flow of water through said pipes 1 and 3;

a plurality of electrolysis modules 5₁, 5₂, . . . 5ₙ which are either hydraulically connected in series and positioned between said inlet and outlet sections of said side water pipe 3, or are hydraulically connected in parallel by being placed on a plurality of subsidiary pipes 11₁, 11₂ . . . 11ₙ branching off from said side water pipe 3;

a power source 6, to which said plurality of electrolysis modules 5₁, 5₂, . . . 5ₙ are electrically connected;

and optionally one or more of the following:

a vent connected to said side water pipe 3 for releasing gaseous products; and

free chlorine measurement device 10 positioned downstream in said main water pipe 1.

The characteristics of the electrolysis modules 5₁, 5₂, . . . 5ₙ are as set forth in detail above. The apparatus of the invention may further comprise flow and pressure measurement devices 7 which can also be placed along the side water pipe 3. A control unit may be employed for regulating the level of chlorine in the water downstream in the main water pipe by adjusting the electrical voltage (or current) supplied to the electrodes by the electrical power source according to the chlorine levels measured by the chlorine measurement device.

### EXAMPLES

The following examples illustrate a set of experiments carried out in a water plant near the town of Ashkelon, Israel, where a groundwater source is used for supplying a stream of drinking water with a volumetric flow rate of 90-110 cubic meters per hour. The experimental arrangements are illustrated in FIGS. 1 and 2, and the working conditions common to both arrangements were as follows:

Salinity of the raw water stream: 400 mg/lit.

Conductivity of the raw water stream: 1300 microsiemens/cm.

Electrolysis module: PSC-5 chlorinator cell (Magen Ecoenergy Ltd., Israel.

Electrode material and dimensions: RuO₂-coated titanium plates, with length and width of 18 cm and 10 cm, respectively, and thickness of 1 mm.

Number of electrodes in the electrolysis module: seven. Electrical connections of the electrodes: as shown in FIG. 4B.

DC supplier: rectifier operating at 12 volt and 60 ampere.

Diameter of the main water pipe: 12 inches.

In the experiments, the level of available free chlorine produced by the method of the invention was measured at a point located approximately 5 meters downstream the point at which the return line of the side water pipe joins the main pipeline. The chlorine indicator used was implemented by a ProMinent DULCOMETER® D1C Single Channel Controller using a ProMinent CLE 3 (.1)-mA-xppm sensor.

### Example 1

The apparatus illustrated in FIG. 1, with six electrolysis modules being hydraulically connected in series and electrically connected in parallel to the DC supplier, was operated for 90 days. The diameter of the side water pipe was 3 inches. During the test period, the side water stream 3w passed through the electrolysis modules (which were assembled in series between the inlet section of pipe 3 and the return line of pipe 3 connected downstream to the main water pipe) at a flow rate of 10-12 m³/hour. The linear velocity of the side water stream was about 0.5 m/s. The polarity of the electrodes was reversed once in 1 hour. During the test period, the residual chlorine level measured in the main water stream was about 0.35 mg/liter. The electrolysis modules were occasionally observed for scale formation. Scale was not observed on the plates and only small amount of deposit was found on the lateral edges of the module.

### Example 2 (Comparative)

The apparatus illustrated in FIG. 2, with six electrolysis modules being hydraulically connected in parallel to one another and electrically connected in parallel to the DC supplier, was operated for 150 days. During the test period, the linear velocity of the stream water passing through each of the branched off subsidiary pipes 11₁, 11₂ . . . 11₆ was about 0.05 m/s. The polarity of the electrodes was reversed once in 1 hour. During the test period, the residual chlorine level measured in the main water stream was about 0.3 mg/liter. The electrolysis modules were occasionally observed for scale formation. Every three days back wash was done and the cells were periodically cleaned with hydrochloric acid in order to remove the scale blockage.

1) A method for chlorination of drinking water, comprising providing a main water stream flowing through a main water pipe at a volumetric flow rate of not less than 30 m³/hour, splitting off a portion of said main water stream to form a side water stream flowing through a side pipe, passing said side water stream through a plurality of electrolysis modules at a linear velocity of not less than 0.35 m/s, wherein each electrolysis module comprises at least one anode and one cathode, electrolyzing the side water stream, and directing the resultant electrolyzed side water stream, which contains free chlorine, back to the main stream.

2) A method according to claim 1, wherein the side pipe comprises two non-contiguous sections, an upstream inlet section and a downstream outlet section, wherein the electrolysis modules are hydraulically connected in series and positioned between said sections.

3) A method according to claim 1, wherein the linear velocity of the side water stream in between 0.5-2.0 m/s.

4) A method according to claim 1, wherein the salinity of the side water stream prior to electrolysis is the natural salinity.

5) A method according to claim 4, wherein the salinity of the side water stream prior to electrolysis is between 70 and 400 mg/liter.

6) A method according to claim 2, wherein the ratio between the diameter of the main water pipe and the diameter of the upstream inlet section of the side water pipe is at least 2:1.

7) A method according to claim 2, wherein the side water stream is passed through at least three electrolysis modules which are electrically connected in parallel to DC supplier, wherein each module comprises p electrodes, p being an integer between 3 and 15, and wherein said electrodes provide p−1 electrolytic cells within the electrolysis module.

8) A method according to claim 7, wherein the electrodes are flat rectangular plates, which are placed in parallel to each other, with the number of electrodes p being equal to 7 or 11, wherein the electrodes assigned with odd numbers (1, 3, . . . , p) are alternately connected to the opposite poles of the DC supplier, such that the outermost electrodes in the electrode assembly are electrically connected to the opposite poles of the DC supplier and the electrodes assigned with even numbers (2, 4, . . . , p−1) are floating electrodes.

9) A method according to claim 1, wherein the main water stream flows at a volumetric flow rate of not less than 250 m³/hour, the method comprises branching off the side water stream into two or more subsidiary streams flowing in parallel, passing each of said subsidiary streams through at least one electrolysis module, electrolyzing said subsidiary streams, combining the electrolyzed subsidiary streams and directing the combined electrolyzed stream back into the main stream.

10) A method according to claim 1, which further comprises periodically reversing the polarity of the electrodes.

11) Water supply system suitable for use in a water pumping station, comprising:
a main water pipe 1 conveying water at a flow rate of not less than 30 m³/hour;
a side water pipe 3 having an inlet and outlet sections in fluid communication with said main pipe 1;
flow control devices 4, 4a for regulating and controlling the flow of water through said pipes 1 and 3;
a plurality of electrolysis modules 5₁, 5₂, . . . 5ₙ which are either hydraulically connected in series and positioned between said inlet and outlet sections of said pipe 3, or are hydraulically connected in parallel by being placed on a plurality of subsidiary pipes 11₁, 11₂ . . . 11ₙ branching off from said side pipe 3; and
an electrical power source 6, to which said plurality of electrolysis modules 5₁, 5₂, . . . 5ₙ are electrically connected.

12) A system according to claim 11 further comprising a vent connected to said pipe 3 for releasing gaseous products and free chlorine measurement device 10 positioned downstream in main pipe 1.

13) A system according to claim 12, further comprising control means adapted to receive chlorine measurements from the chlorine measurement device and responsively adjust the voltage level supplied by the power source for adjusting the chlorine level in the water.
